(19) United States
(12) Patent Application Publication
(10) Pub. No.: US 2008/0274236 A1
(43) Pub. Date: Nov. 6, 2008

(54) Apparatus and a Method for Producing Ice Confection

(75) Inventor: Ejvind Waldstrom, Risskov (DK)

Correspondence Address: CANTOR COLBURN, LLP, 20 Church Street, 22nd Floor, Hartford, CT, 06103, US

(73) Assignee: TETRA LAVAL HOLDING & FINANCE S.A., Pully (CH)

(21) Appl. No.: 11/578,651

(22) PCT Filed: Apr. 13, 2005
(86) PCT No.: PCT/DK05/00248

§ 371 Date: Oct. 13, 2006

(30) Foreign Application Priority Data
Apr. 15, 2004 (DK) PA 2004 00593

(51) Int. Cl. A23G 9/26; A23G 9/48

(52) U.S. Cl. 426/91; 425/453; 425/126.2; 425/120; 425/134; 425/225; 426/512; 426/101

(57) ABSTRACT

The invention relates to an apparatus and a method for producing ice confection, comprising a carousel arrangement which comprises a plurality of arms which are provided with a plurality of moulds having mould cavities for the moulding of ice confection, by which carousel arrangement are arranged process means for producing ice confection by advancing the arms between the process means for performing partial processes at a number of stations, moulds being placed with their openings oriented downwards at one or more of the stations.

The present invention relates to an apparatus and a method for producing ice confection, i.e. ice products with a core of ice cream or water ice enclosed within a cover shell.

Several methods are known for producing ice confection. A first method comprises extrusion of the core material for cutting into portions with subsequent freezing in cold air and application of a cover consisting of chocolate or juice. A second method comprises moulding in mould cavities by filling in a layer of cover material to form a shell and subsequent filling in core material such as ice cream or water ice, and finally application of a sealing layer of cover. The present invention concerns an improvement of the latter method.

As an example of a known apparatus for producing ice products is now described an apparatus comprising a number of lamellae which are mutually connected in an endless belt. Each lamella is provided with a row of detachable moulds or formed mould cavities, corresponding to the top and sides of the ice confection. The lamellae are fed stepwise via two chains which are moved by means of chain wheels at each end of the belt run. The production process can, for example, consist of the following:
Pre-cooling the empty moulds in a compartment with cold air,
Filling cover material into the cavities,
Suction of surplus cover material after part of the cover material has solidified into a shell,
Scraping off cover material spilled on the top side of the moulds,
Cooling the shell with cold air,
Filling and levelling core material into the shell,
Possibly inserting a holding stick, if this is desired,
Cooling the core material,
Filling cover material onto the upper side of the core material for sealing the ice confection,
Removing surplus cover material,
Scraping off spilled cover material on the mould plate,
Cooling the shell in cold air,
Removing the ice confection for further processing such as wrapping,
Cleaning the empty moulds, and
Suction of cleaning agent from the moulds.

However, the known apparatus and method involves a great number of partial processes and associated partial process apparatuses, which is time consuming and requires many resources. A large part of these partial processes are utilized for removing surplus material from the ice production, the moulds being oriented opening upwards and the cavity closed downwards. Moreover, potentially incorrectly placed holding sticks have to be removed, which is often carried out manually, and the moulds must be cleaned for impurities, which settle from the air, either during standstill or during operation. As a consequence of these many process steps and the use of a conventional endless belt, such known apparatus often attains a considerable size.

With this known method and apparatus, the suction of excess material must be carried out before filling the core material; intermittent filling means must, after a first filling but before a subsequent filling, be safeguarded against causing tailings, i.e. contaminating drops on the ice confection, and causing contamination of the suspension of the moulds; cleaning fluid must be sucked out from the moulds before filling with cover material, because it out of regard for the ice quality and for reasons of hygiene is important to remove remaining cleaning fluid from the bottom of the moulds, but difficult in practice.

It is on this background the object of the invention to provide an apparatus and a method enabling a faster and more suitable production of ice confection by an apparatus, which occupies lesser space and is easier to clean.

This object is achieved by an apparatus and an associated method for producing ice confection, said apparatus comprising a carousel arrangement comprising a plurality of arms provided with a plurality of moulds having cavities for the moulding of ice confection, by which carousel arrangement is arranged process means for producing ice confection by advancement of the arms between the process means for performing partial processes at a plurality of stations, the moulds being placed to have their openings facing downwards at one or more of the stations.

By arranging the moulds in a carousel arrangement having a plurality of moulds on a plurality of arms, a number of advantages are achieved through an expedient utilisation of the moulds. Firstly, the apparatus can contain a smaller number of moulds than the number necessary in producing the same amount of ice confection on an endless belt, as the stations can be used to concentrate the process means by the carousel arrangement, which can result in a substantially full utilisation of the available space. Secondly, the process means can be arranged closely together around the carousel, which in total reduces the size of the apparatus and the costs associated with its production. Another advantage is that the carousel arrangement affords good access from all sides, which eases the maintenance of the apparatus.

By arranging a plurality of moulds on an arm an advantage is achieved by the fact that the moulds can be arranged upon the arms having consideration of the desire to achieve a good positioning relative to the process means by the carousel arrangement, i.e. adapted to the capacity consideration and the size of the process means provided. The more moulds on an arm, the greater the capacity of the apparatus.

Since the openings in the moulds are placed downwards during one or more of the partial processes, the need for partial processes for the cleaning of the apparatus and the process means associated therewith can be reduced. This further reduces the size of the apparatus and its initial costs.

In one embodiment, the apparatus and the associated method is provided with drive means for stepwise advancement of the arms between the stations. The arms are thus advanced by rotation around the axis of rotation for the carousel with a predetermined frequency, where the period of rest at each station, and consequently the time it takes for an arm to complete a complete carousel round and hereby produce ice confection, which is ready for further processing, is adjusted to the partial process time period of the process means.

In a preferred embodiment, the apparatus comprises one or more of the following process means for performing the method by the following partial processes: Cleaning means for cleaning of the moulds; first filling means for filling the cover material into the mould cavities for the forming of a shell; second filling means for filling core material into the shells; stick insertion means for inserting a holding stick, cooling means for cooling the moulds, sealing means for application of cover material on the core material surface being accessible externally; and emptying and removing means for emptying the ice confection out of the moulds and removing them for further processing. The number of necessary partial processes and accordingly process means for producing finished ice confection is hereby reduced to the lowest number possible.

By the invention it is realised that the shell thickness, which is achieved by adjusting the temperature of the moulds and the cover material in relation to the amount of cover material applied, can be controlled far more precisely than with the hitherto known apparatuses and methods, resulting in a smaller cover material spillage.

In a further embodiment, the apparatus comprises the fact that the process means at two or more stations are the same. A stepwise advancement of the arms with the moulds provides that the arms are present at a station for a predetermined period of time, which is the same at each station. Since certain of the processes can take a longer time than others, e.g. the dripping-off of surplus cover material can take a longer time than the filling, the solution to this is that the process means by the longer-lasting processes are distributed over two or more stations depending on the necessary partial process time period. The advantage is therefore a good utilisation of the room available on the carousel, in the best case process means can be arranged at all stations.

In yet another embodiment, the apparatus comprises the fact that the carousel arrangement is rotating around a vertical axis of rotation. With such a configuration of the apparatus, the process means can expediently be arranged under or over the arms by adjustment of the size of the process means to the length of the arm or vice versa, and by utilising natural dripping off by a suitable positioning of collection means at one or more of the partial processes.

In yet a further embodiment, the apparatus comprises actuator means for movement of at least one of the arms and/or the process means in a direction which is substantially parallel with the axis of rotation of the carousel arrangement. The process means or the arms can thus be moved individually in relation to one another which, for example, means that the filling can be performed at a high degree of control of the amount of material used, and material wastage can hereby be reduced.

In a further embodiment, the apparatus comprises drive means for the turning of the moulds during or after advancement of the arms to one or more of the stations. The turning drive means ensure the choice of turning the moulds at desired stations for the placing the moulds' openings downwards or upwards.

In certain embodiments, the method comprises the fact that the mould openings are oriented downwards during the filling of the mould cavities, and/or during cleaning of the cavities, and/or at all stations. Thus, it is possible for cooling and cleaning fluids and excess ice confection materials to drip off under the influence of gravity, without the need for further cleaning partial processes and associated process means, which results in a less costly apparatus and an increased capacity. A manual removal of incorrectly-placed holding sticks can advantageously be dispensed with.

In a preferred embodiment, the method comprises the fact that the core filling material is high-viscous, the core material may be comprising low-temperature ice cream and/or partly crystallised water ice. The probability of the core material remaining in the mould cavity after filling of highly viscosity core material is higher than of a low-viscous core material. A further advantage comprises the fact that possible holding sticks can be inserted without requiring a partial process of subsequent freezing for fastening of the holding stick, the reason being that the high-viscous core material advantageously is fastening the holding stick.

In the following, the invention will be described in further detail with reference to the accompanying drawings, where

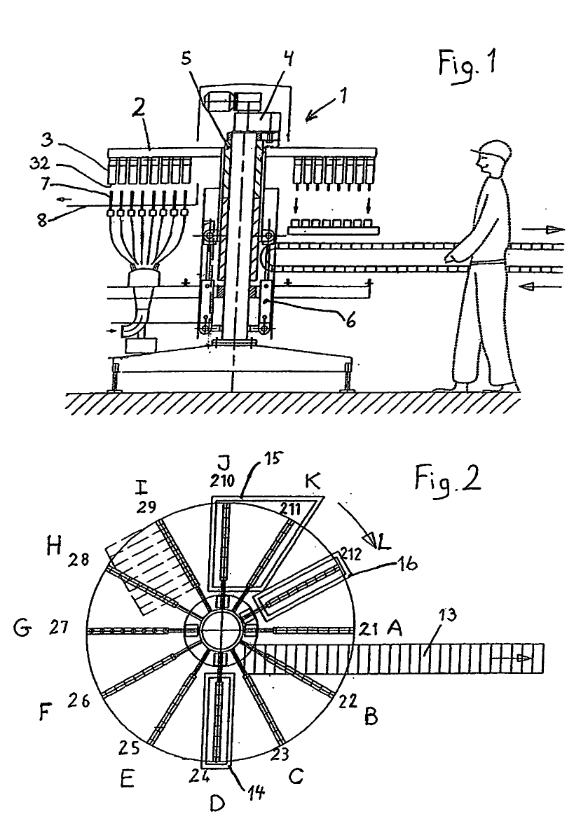

FIG. 1 shows a schematic side view of an embodiment of an apparatus for producing ice confection according to the invention and

FIG. 2 shows a schematic view of the apparatus of FIG. 1 seen from above.

In FIG. 1 is shown an embodiment of an apparatus according to the present invention comprising a carousel arrangement 1 with an inner ring 5 provided with a plurality of arms 21, 22, . . . , 212 (in a number of twelve in the example shown), on which a plurality of mould tubes or moulds 3 (in a number of eight in the example shown) are suspended with the opening of the moulds 3 oriented downwards during the entire production process. The carousel arrangement 1 is rotated by the inner ring 5 around a vertical centre axis by drive means 4, in such a way that the arms 21, 22, . . . , 212 can be advanced stepwise to the stations, at which process means are arranged for the performance of partial processes of the ice confection production. In the left-hand half of FIG. 1, one of the arms is shown at a station having filling tubes 7 for filling core material into shells, which are formed in the mould cavities 32 in the moulds 3, and in the right-hand half of the figure one of the arms is shown arranged at a station where releasing of the ice confection is performed. The arms 3 are arranged in such a way that they may be displaced individually or jointly in the vertical direction, or alternatively the process means may be displaced individually or jointly in the vertical direction, by means of one or more actuators 6.

In FIG. 2 is shown an apparatus of FIG. 1 seen from above, where said apparatus advances the twelve arms to a number of stations A, B, C, . . . , L (in a number of twelve in the example shown), which thus corresponds to the number of arms. Alternatively, the number of stations can be larger or smaller than the number of arms. Since the stations can be used for concentrating process means by the carousel arrangement, the total number of moulds necessary can be reduced to a small number compared to the known apparatuses. In the example shown, this leads to inactivity only at one station, namely H, which corresponds to a mould utilisation degree of approx. 92%.

The process means at station A comprise releasing means for emptying the moulds and the removal of the finished ice confections, here by transfer to a conveyor 13. The emptying can be effected in different ways. The products may be transferred from the moulds to the conveyor by means of gripping elements which take out and retain the product during transfer. The moulds may be configured in two parts, the emptying being effected by opening of the two-part moulds, whereby the ice confection is released. The moulds may also be configured as an entity comprising a mould cavity having an increasing cross section towards the mould opening, which facilitates the extraction of the products. The moulds may be heated or cooled for attaining a slip effect between the product and the mould surface brought about by differences in the heat expansion coefficient between ice confection and moulds.

At station B and C no process means are shown, but cleaning means may advantageously be arranged at this position to provide for a cleaning of the moulds of possible residual products by washing with water, air or brushing into the moulds and for the dripping off of possible remaining cleaning fluid. The cleaning of the moulds is normally performed only before and after production start in order to keep the moulds cold.

At station D first filling means are arranged for sluicing or spraying cover material, such as liquid chocolate or juice, up into the moulds. Part of this cover material will solidify upon the surface of the colder mould cavity, and it will thus build up a thin-walled cover shell. The shell thickness being achieved can be controlled very accurately by adjusting the temperature of the moulds and the cover material in relation to the amount of cover material applied, which not only results in a reduced waste of cover material, but also enables a predetermined local positioning of the cover material or as a pattern on the surface of the mould cavity.

The process means at station D, E and F comprise means such as trays or the like for the entrapment of surplus cover material dripping off.

At station G are arranged second filling means for filling of the core material, which comprise a plurality of filling tubes 7 (see FIG. 1) to be inserted into the base of the shells now formed inside the mould cavities 32. By the use of actuator means 6 being provided, the moulds are moved upwards and/or the filling tubes are moved downwards concurrently with the core material flowing out from the filling tubes 7, and the shells are filled up with core material, whereupon the filling is stopped immediately before the filling tubes 7 are moved clear of the opening of the moulds 3. Possible tailings, i.e. surplus drops originating from the filling of the core material, drops of core material or of low-viscous core material during start-up, will run down the filling tubes and is collected in a drain tray 8, from where this spillage can be led away without soiling the moulds 3. The core material preferably consists of high-viscous material, such as low temperature ice cream, having a temperature from around −8° to around −15° C. and/or partly crystallised water ice.

At station H and I is arranged a stick inserter occupying two stations by the storage for the holding sticks, which inserter at station I inserts the holding sticks by forcing part of the length of the holding sticks into the high-viscous core material. With the use of high-viscous core material, the holding sticks are advantageously secured by the core material.

At station J are placed cooling means, which provide for a cooling of the moulds by individual lowering of the arms, such that the moulds are dipped down into an underlying vessel 15, which may contain liquid nitrogen or a similar coolant, or alternatively by raising the vessel 15. This cooling is optional because by using high-viscous core material, such as low temperature ice cream or crystallised water ice, a pre-cooling of the ice confection has already been provided. By using supplemental cooling means, the surplus heat from the shell or the sealing can be removed, or the ice confection may be made to loosen itself from the mould by differences in the heat expansion coefficient for the moulds and the ice confection. At station K the surplus coolant drips down into the underlying vessel 15.

At station L a sealing layer of cover material is applied to the free surface of the core material and to part of the holding stick in the opening of the mould in such a way that the shell completely surrounds the core. This is performed by lifting the cover material from an underlying supply pipe 16, alternatively from a vessel by means of adhesion to a surface, sponge or the like. When, as in the shown example, using a freezing process immediately before sealing, the applied cover material will advantageously solidify quickly and can hereby substantially be prevented from running down along the holding stick to the area where the holding stick is normally held, when the ice confection is being consumed. One or more surfaces and/or sponges or the like can apply the sealing by a straight or oblique movement or by swinging upwards.

During operation, the arms 21, 22, . . . , 212 are advanced to the process means by rotation of the carousel arrangement 1 during which the following partial processes take place: Cleaning the mould cavities (normally only at the production start and end), application of cover material into the mould cavities in order to form a shell, filling core material into the shells, inserting holding sticks into the ice confection, cooling cover material and core material, application of cover material upon the surface of the externally-accessible core material in the mould cavity, and emptying the ice confection from the moulds and removing these for further processing.

During operation it has been found that the shown apparatus according to the invention has achieved a capacity of around 10,000 ice confection products an hour. Obviously, by varying the number and the length of the arms, the number of moulds, the number of process means, etc. the apparatus is capable of achieving any capacity desired.

Obviously, the skilled person within the art can envisage the above described apparatus and method according to the invention in other ways. In an alternative apparatus it is provided with drive means for individual rotation of the arms for a turning of the openings of the moulds at stations where this is expedient, e.g. for a turning of the mould openings facing downwards at stations having process means where, for example, the filling, emptying and/or cleaning of the moulds is taking place, or a turning of the mould openings upwards during dipping into, or filling of the moulds with coolant or the like, including the turning of the moulds in such a way that these are at an angle in relation to the vertical direction, where this could prove to be expedient, e.g. during application of the sealing. Another alternative configuration for larger capacity may be to make the arms longer having more moulds, and suspend the arms between two chains which run forwards in a stepwise manner. The lowermost chain loop, where the moulds turn having their openings facing downwards, can then be utilised for the above-mentioned partial processes. Having the chains turning around chain wheels at each end, the arms are returned via the uppermost chain loop.

1.-19. (canceled)

20. An apparatus for producing ice confection comprising:
a carousel arrangement, which comprises a plurality of arms which are provided with a plurality of moulds having mould cavities for moulding of ice confection,
by which carousel arrangement process means are arranged for producing ice confection by advancing the arms between the process means for performing partial processes at a number of stations, at least one station having filling means arranged for filling of the mould cavities, the moulds being placed to have their openings oriented downwards at one or more of the stations and at least when said mould cavities are in a position for being filled by said filling means.

21. An apparatus according to claim 20, where the apparatus is provided with drive means for stepwise advancement of the arms between the stations.

22. An apparatus according to claim 20 comprising one or more of the following partial process means for performing the partial processes:
cleaning means for cleaning the moulds,
first filling means for filling cover material into the mould cavities for forming of a shell,
second filling means for filling core material into the shells,
stick insertion means for the insertion of holding sticks,
cooling means for cooling the moulds,
sealing means for applying cover material upon a surface of a core material being externally accessible and
emptying and removal means for emptying the ice confection from the moulds and removing these for further processing.

23. An apparatus according to claim 20, where the process means are the same at two or more stations.

24. An apparatus according to claim 20, where the carousel arrangement rotates around a vertical axis of rotation.

25. An apparatus according to claim 20, where the apparatus comprises actuator means for moving at least one of the arms in a direction being substantially parallel to an axis of rotation of the carousel arrangement.

26. An apparatus according to claim 20, where the apparatus comprises actuator means for moving at least one of the process means in a direction being substantially parallel to an axis of rotation of the carousel arrangement.

27. An apparatus according to claim 20, which comprises drive means for turning the moulds during or after advancement of the arms to one or more of the stations.

28. A method for producing ice confection, comprising
moulding ice confection in a plurality of moulds having mould cavities, the moulds being arranged on a plurality of arms arranged in a carousel arrangement by which process means are arranged for producing ice confection, and
advancing the arms between the process means at a plurality of stations, the mould openings facing downwards at least during filling of the mould cavities at one or more of the stations.

29. A method according to claim 28, where the advancement of the arms between the stations takes place in a stepwise manner.

30. A method according to claim 28, comprising one or more of the following partial processes and not necessarily in the stated sequence:
cleaning the mould cavities;
filling cover material into the mould cavities for forming of a shell;
filling the shells with core material;
insertion of holding sticks into the ice confection;
cooling cover material and core material;
application of cover material upon a surface of externally-accessible core material in the mould cavity; and
emptying the ice confection from the moulds and removing it for further processing.

31. A method according to claim 30, where the openings in the moulds are oriented downwards during cleaning of the mould cavities.

32. A method according to claim 31, where a cover material is applied to the mould cavities by sluicing or spraying up into the moulds.

33. A method according to claim 32, where the cover material is applied only to partial sections of the mould cavities.

34. A method according to claim 28, where the openings in the moulds are oriented downwards at all of the stations.

35. A method according to claim 30, where the filled in core material is high-viscous core material.

36. A method according to claim 35, where the core material comprises low-temperature ice cream.

37. A method according to claim 35, where the core material comprises partly crystallised water ice.
